(19) United States
(12) Patent Application Publication
(10) Pub. No.: US 2012/0159836 A1
(43) Pub. Date: Jun. 28, 2012

(54) "Gnat Vac" indoor grow room flying insect control

(75) Inventor: Kevin Scott Brown, Roseville, MI (US)

(73) Assignee: Kevin Scott Brown, Roseville, MI (US)

(21) Appl. No.: 12/927,902

(22) Filed: Dec. 27, 2010

(51) Int. Cl. A01M 1/04

(52) U.S. Cl. 43/113

(57) ABSTRACT

The gnat vac is a trap designed for indoor gardens to eliminate flying insects, and is used primarily at night or during lights out time of operation. The unit utilizes a green light bulb to naturally lure flying insects to inlet of trap, in which they are vacuumed into receptacle and contained in a filter for easy disposal. Effectively controlling flying insects without disrupting photo period of flowering plants.

### BRIEF SUMMARY OF THE INVENTION

This invention relates to flying insect control. Particularly to controlling flying insects populating indoor grow room's, as well as greenhouse's although it can be used during the day, primarily used for “lights out” or night time operation. The gnat vac is a custom designed, earth friendly luring receptacle trap. The gnat vac as I Kevin Scott Brown call my invention is a receptacle trap outfitted with a green light to lure flying insects naturally to the mouth of the receptacle where they are vacuumed or sucked into the receptacle via inline duct fan.

The light on the inlet of receptacle has two functions. First, light naturally lures flying insects to the inlet of the trap and secondly the green colored bulb does not affect or disrupt the photo period of flowering or budding plants. So it is used primarily at night, while you and your plants sleep.

The gnat vac is particularly effective to trap flying insects such as fungus gnats, whiteflies, winged aphids, leaf miners, even adult thrips and moths have been found in the receptacle, all of which are very common pest to the horticulturist. The receptacle can easily be opened to filter and put back to work. I Kevin Scott Brown have built a medium size version of the trap, have thoroughly tested it and swear it works very well. Smaller and larger versions can be made to accommodate any size indoor grow room or green house. The following is all the directions as well as supplies and tools necessary to build a medium size prototype of the “Gnat Vac”

### DETAILED DESCRIPTION OF INVENTION

The gnat vac flying insect receptacle trap is a custom designed luring receptacle, outfitted with a green light bulb to lure flying insects to the mouth of the trap where they are vacuumed or sucked into the trap via inline duct fan and contained in a filter. The gnat vac is designed for use inside indoor grow rooms and green houses primarily at night or during the lights out time of operation. One advantage of the green light bulb is that it naturally attracts flying insects, the other big advantage is that it does not affect the photo period of flowering or budding plants.

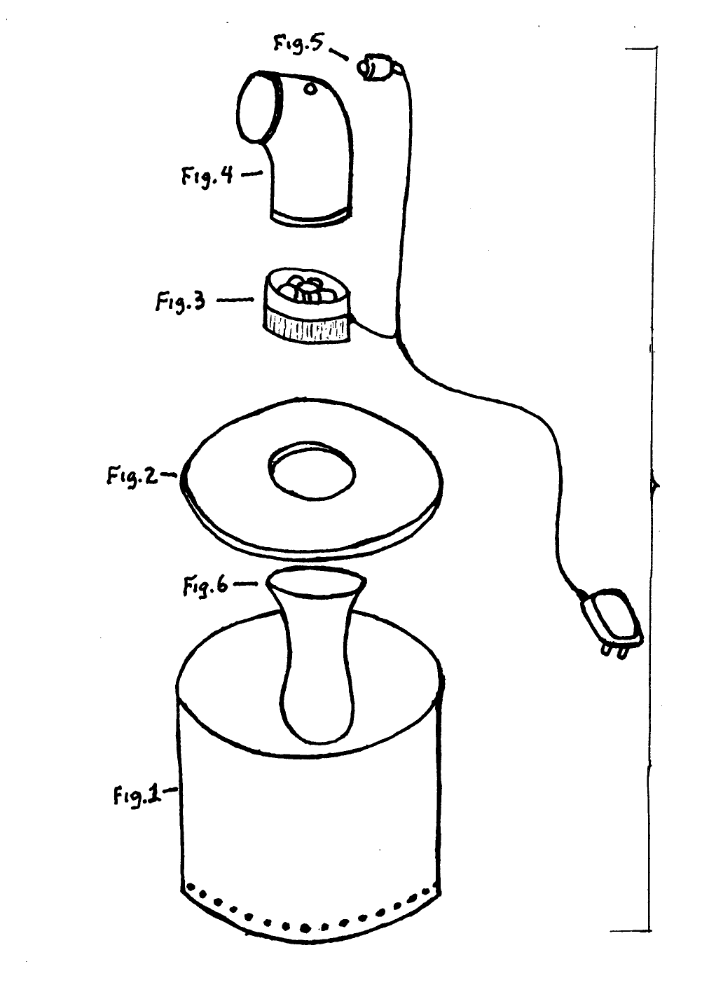

To manufacture a medium size prototype first drill a six inch hole in FIG. 2 using a drill and six inch hole saw then insert FIG. 3 into six inch hole and seal with silicone bead. Next attach FIG. 4 to top of FIG. 3 and seal with silicone bead, allow silicone to cure or dry. Next, using a 5/16 drill bit, drill hole in FIG. 4 about middle of bend in p.v.c pipe, or 4 inches from top of elbow. Install FIG. 5 in drilled hole and seal with silicone bead. Next using a 5/16 drill bit drill approximately fifty holes on sides of bucket along entire bottom of bucket, one inch from the bottom of bucket to serve as a diffuser and to create negative pressure once fan is in operation. Next install nylon filter onto bottom of FIG. 3 and secure with rubber band. Insert completed top assembly onto bottom previously drilled bucket.

The unit is now ready for operation. Plug unit in to any 110 volt outlet of a flying insect populated indoor grow room at night, or during the lights out time of operation, and see great results.

supplies that are needed:

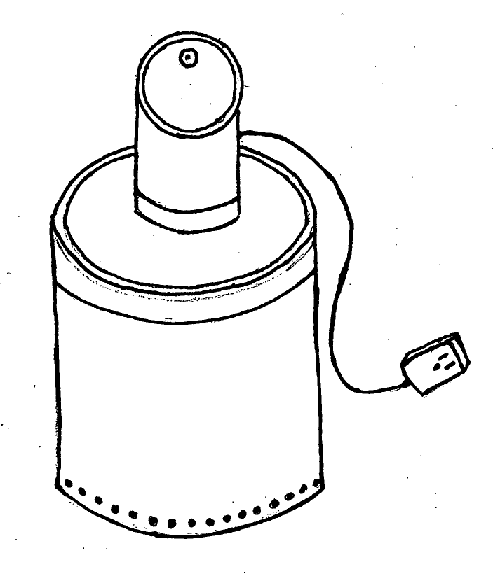

FIG. 1—black bucket

FIG. 2—matching lid to bucket

FIG. 3—6 inch inline duct fan

FIG. 4—90 degree 6 inch p.v.c elbow

FIG. 5—green l.e.d light bulb

FIG. 6—nylon filter

tools that are needed:

Cordless drill

6 inch hole saw

5/16 drill bit

Clear silicone or rtv

Rubber band

1. I claim my invention described to be a custom designed flying insect receptacle trap. The receptacle is outfitted with a green light bulb, a suction fan and a filter. When used inside indoor grow rooms and green houses during night time hours or lights out operation, has proven to be very effective at luring and eliminating flying insect, without disrupting photo period of flowering or budding plants.
